(19) United States
(12) Patent Application Publication
(10) Pub. No.: US 2012/0095614 A1
(43) Pub. Date: Apr. 19, 2012

(54) ELECTRONIC CONTROL DEVICE AND METHOD FOR BOILER SYSTEM

(76) Inventor: Richard DeLayo, Bronx, NY (US)

(21) Appl. No.: 12/905,057

(22) Filed: Oct. 14, 2010

(51) Int. Cl. G05D 23/00; G06F 21/00; G06F 13/38

(52) U.S. Cl. 700/300; 710/63; 726/27

(57) ABSTRACT

An electronic control system for boilers uses remote sensors, data logging, and communications. The system allows the user to reduce the output temperature of a boiler system during times of reduced demand or for adjustments of seasonal functionality. The system has a processor unit for processing and displaying information, communication and for interfacing with a set of control relays. Integrated relays allow control of boiler operating temperature and set points. Microcontroller operated remote sensors provide data and logging feedback.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to temperature responsive control systems and particularly to an electronic control system for boilers which uses remote sensors, data logging, and communications and which comprises a processor unit for processing and displaying information, communication and for interfacing with a set of control relays, integrated relays that allow control of boiler operating temperature and set points, and microcontroller operated remote sensors that provide data and logging feedback; the system allows the user to reduce the output temperature of a boiler system during times of reduced demand or for adjustments of seasonal functionality.

2. Description of Related Art Including Information Disclosed Under 37 CFR 1.97 and 1.98

Water heaters that maintain a high temperature continually throughout the day, regardless of demand for hot water, waste a substantial amount of energy in heating and reheating water to a high temperature when that high temperature water is not needed. While other devices have attempted to solve this problem, they often lack failsafe control or continual remote monitoring capability of a number of parameters which enable discovery of faulty components in the devices as well as in the boilers.

U.S. Patent Application #20080314337, published Dec. 25, 2008 by Teti, indicates a water heater control system and method of using a set-back or programmable thermostat for heating or cooling systems to also controlling a fast-recovery water heater such as a power-vented fossil fuel powered water heater such that the water heater is disabled during a set-back mode of the thermostat. The system sends a control signal to a relay module adjacent to the water heater, into which the water heater electrical power cord can be plugged into. The interlock mechanism of the water heater prevents operation of the water heater when power to the water heater is interrupted.

U.S. Patent Application #20070179678, published Aug. 2, 2007 by Nordberg et al, illustrates water heater energy savings algorithm for reducing cold water complaints. The water heater which tracks usage is controlled by an energy savings algorithm that uses one or more of a variable setpoint differential, a variable setback threshold, additional setback thresholds, and an adjustable minimal setpoint to improve the operation of an energy efficient water heater. Additionally or alternatively, a different setback control algorithm may be used that obtains additional data to adjust the setpoint. As a result, the operating cost of the water heater is reduced, while minimizing user complaints of cold water.

U.S. Patent Application #20070051819, published Mar. 8, 2007 by Isaacson, describes a water heater with programmable temperature mode. The temperature in a water tank (e.g., a residential water tank) is monitored, and a controller switches between a high temperature mode of operation and a low temperature mode of operation (e.g., based on a daily or weekly program). During the low temperature mode of operation, the controller generates signals to selectively activate a water heater to keep the water's temperature within a first range of values, (e.g., between 105 and 113.degree. F.). During the high temperature mode of operation, the controller generates signals that cause the water heater to heat the water to a temperature that is above the first range of values. This arrangement may be used for saving energy by operating in the low temperature mode at night and during those parts of the day when nobody is home, and by operating in the high temperature mode in the morning and evening when the demand for hot water is typically high. This arrangement is also well-suited for day-care centers and nursing homes, in which case the low temperature mode is used to reduce the risk of scalding. It is also useful in the homes of people who wish to avoid violating a religious injunction that prohibits heating liquids beyond a threshold temperature on the Sabbath.

U.S. Patent Application #20090234513, published Sep. 17, 2009 by Wiggins, discloses an electronic controller and a computer-implemented method for a water storage system. The water storage system has a storage tank connected to a main energy source and a main water source. The electronic controller is provided with at least one sensor to generate a sensor signal representing the state of the water in the storage tank. There is also an input device for a user to input a command signal into the controller. A processor in the controller receives the sensor signal, command signal, and source information relating to at least one of the main energy source and main water source. Based on the source information and at least one of the sensor signal and the command signal, the processor controls one or more of the following aspects of the water storage system: the use of water from the main water source, the use of energy from the main energy source, the state of water in the tank, and the use of water from the tank.

U.S. Patent Application #20100088261, published Apr. 8, 2010 by Montalvo, claims a method and system for fully automated energy curtailment. The fully automated demand response may be implemented at end users, in accordance with terms agreed to by end users to reduce energy demand during demand response events. Demand reduction actions to implement the objectives of a demand response event at the end users may be determined, desirably using artificial intelligence and neural networks, based on energy demand curtailment objectives of the demand response event, hierarchy(ies) of demand reduction actions for respective demand response events ordered to minimize undesired impact at the end users, and monitoring data received from, or relating to implementing energy demand curtailment at, the end users. In addition, demand reduction actions may be automatically implemented at end users in the absence of a demand response event, to implement energy demand curtailment according to criteria of end users, where the demand reduction actions are determined based on monitoring data and a hierarchy(ies) of demand reduction actions and using artificial intelligence and neural networks. In an alternative embodiment, control signals may be transmitted directly to appliances which may include therein, for example, a variable speed drive, a chiller controller, a boiler controller for controlling operation of the associated appliance.

U.S. Patent Application #20100153030, published Jun. 17, 2010 by Yatir et al, discloses an apparatus for monitoring and controlling an electrical boiler. A method is provided for determining the amount of warm water in a water tank, comprising: pre-determining various situation graphs, each graph describing the variation of the water temperature as a function of time, in one specific operational situation of the system; dividing each of said graphs in a plurality of sections; determining for each graph section the percentage of warm water in the tank; storing in a memory said graph sections, and the corresponding percentage of warm water in the tank; during the operation of the heating system, sampling periodically the temperature in the tank; for each sequence of samples, finding the most similar graph section, and the percentage of warm water that corresponds to said graph section; and displaying to the user said present percentage of warm water in the tank.

U.S. Patent Application #20080277488, published Nov. 13, 2008 by Cockerill, illustrates a method for controlling HVAC systems. The method is for adjusting the source activation time of a heating or cooling source is based upon variation in temperature sensor or thermostatic means activity within a controlled environment, and involves activating and deactivating the heating or cooling source to provide precise heating or cooling BTU replacement. This method changes the priority of heating and cooling management from a fixed source output, which is called upon by a controlled environment thermostat, to a system of adjusting the source output to the precise delivery of source output to the needs of the enclosed environment at an ideal thermostat demand ratio within the controlled environment.

U.S. Patent Application #20090293816, published Dec. 3, 2009 by Patterson et al, puts forth systems and methods for estimating and indicating temperature characteristics of temperature controlled liquids. A system in accordance with one exemplary embodiment of the present disclosure has a tank filled at least partially with a liquid, such as water, and the system has a plurality of temperature sensors mounted on the tank. During operation, a controller compares temperatures sensed by these temperature sensors to a predefined temperature profile for the liquid within the tank in order to estimate the likely temperature characteristics of such liquid. The controller then reports these estimated temperature characteristics via a user interface. As an example, the controller may estimate and report the amount of liquid above a threshold temperature that can be drawn from the tank. Based on the reported temperature characteristics, a user may make decisions about whether or how to use liquid drawn from the tank.

Three U.S. Patent Applications, #20100082134 published Apr. 1, 2010; #20070246551 published Oct. 25, 2007 and #20070245980 published Oct. 25, 2007 by Phillips et al, concern a water heater having a modular control system which tracks usage. The water heater includes a tank, a heating element, a first controller, and a second controller. The heating element is coupled to the tank. The first controller is supported by the tank and includes a housing, a first communication port, a processor, and a first memory storing executable instructions that are executed by the processor. The first controller determines whether the first controller is connected to the second controller through the communication port. The first controller controls an operation of the water heater according to a first algorithm when the first controller is not connected to the second controller. The operation of the water heater is controlled based on an algorithm stored on the second controller when the first controller is connected to the second controller.

U.S. Patent Application #20090090788, published Apr. 9, 2009 by Rogues, claims a control device for conserving energy for heating water contained in a water heater which includes: an electronic detection device for measuring the quantity of hot water remaining in the tank, the electronic detection device including a capillary tube containing a heat transfer fluid and an amplification device placed outside the tank of the water heater and connected to an electronic control card, the amplification device being suitable for transmitting a variation in resistance to the electronic control card under the effect of the expansion of the fluid contained in the capillary tube, and control elements connected to the electronic control card for determining the hot water consumption profile of the users in order to control the period or periods of resumption of the heating of the water in the tank. A consumption profile may be acquired via the control means allowing a calculation by compiling a record of the quantities of hot water consumed as a function of the time and the day.

U.S. Patent Application #20070183758, published Aug. 9, 2007 by Bradenbaugh, claims a water heater including a water inlet line having an inlet opening that introduces cold water to a tank, a water outlet line having an outlet opening that withdraws heated water from the tank, and a heating element. The water heater further includes a control circuit. The heating element can be an electrical resistance heating element, a gas heating element, or a combination thereof. In one construction, the gas heating element includes a first combustive section and a second combustive section separately controlled from the first combustive section.

Two U.S. Patent Applications, #20050230490 and #20050230491 published Oct. 20, 2005 by Pouchak et al, describe methods and systems for controlling boiler systems which may track runtime and usage. In one embodiment, a derivative action control is used reduce the likelihood of overshoot from a newly activated boiler. When a newly activated boiler becomes active, the boiler is held at a low firing rate for a predetermined period of time. The predetermined period of time may be cut short or even entirely eliminated under certain conditions. The methods and devices are further adapted for use in multi-stage boiler systems. In one embodiment, only the first stage of a multi-stage boiler system that becomes active is held at the low firing rate.

U.S. Patent Application #20070108187, published May 17, 2007 by Ding et al, indicates systems and methods of heating an accurate quantity of a fluid. A determination is made that an event in which a relatively large quantity of hot water is used has occurred. One or more temperatures are sensed. An increase in a temperature set point is made if the sensed temperatures indicate a shortage of hot water for the event. A decrease in the temperature set point is made if the sensed temperatures indicate an excess of hot water was available for the event. No change is made to the temperature set point if the quantity of hot water available for the event was appropriate.

Five U.S. Patent Applications, #20030091091 and #20030093186 published May 15, 2003; #20040158361 published Aug. 12, 2004; #20040225414 published Nov. 11, 2004 and #20100030396 published Feb. 4, 2010 by Patterson et al, put forth a system for controlling a temperature of a liquid residing within a tank comprising a temperature sensor, a temperature control element, memory, and logic. The temperature sensor is configured to detect the temperature of the liquid residing within the tank, and the temperature control element is coupled to the tank. The memory stores data indicative of a usage history of the tank, and the logic is configured to automatically control the temperature control element based on the data.

U.S. Pat. No. 7,432,477, issued Oct. 7, 2008 to Teti, concerns a system and method of using a set-back or programmable thermostat for heating or cooling systems to also controlling a fast-recovery water heater such as a power-vented fossil fuel powered water heater such that the water heater is disabled during a set-back mode of the thermostat. The system sends a control signal to a relay module adjacent to the water heater, into which the water heater electrical power cord can be plugged into. The interlock mechanism of the water heater prevents operation of the water heater when power to the water heater is interrupted.

U.S. Pat. No. 7,506,617, issued Mar. 24, 2009 to Paine, is for a control system for a modulated heating system including a plurality of modulating water heaters, which may be modulating boilers. A deadband control scheme provides for reduced cycling of the modulating heater when total system heat demand falls between the maximum output of one heater and the sum of the maximum output of that one point and the minimum firing point of the next subsequent heater.

U.S. Pat. No. 6,647,302, issued Nov. 11, 2003 to Pouchak, shows a human interface panel for boiler control system. A method of analyzing information from a boiler control system is provided which includes providing a series of status modes with each status mode represented as an input condition to be tested. A relative priority structure is established among the status modes and a unique message is associated with each status mode having an input condition that is true. Individual status modes are then tested in an order defined by the priority structure until a status mode in a true condition is found. The unique message associated with the status mode found to be true is displayed.

Five U.S. patents, U.S. Pat. No. 7,346,274 issued Mar. 18, 2008; U.S. Pat. No. 6,633,726 issued Oct. 14, 2003; U.S. Pat. No. 6,455,820 issued Sep. 24, 2002; U.S. Pat. No. 6,374,046 issued Apr. 16, 2002 and U.S. Pat. No. 6,363,216 issued Mar. 26, 2002 to Bradenbaugh, claim a water heater and method of controlling the same wherein the memory further includes a usage pattern, wherein the processor is further operable to develop the usage pattern based on the sensed temperature, and wherein the processor determines the ratio further based on the usage pattern.

U.S. Pat. No. 6,536,678, issued Mar. 25, 2003 to Pouchak, discloses a boiler control system and method. The method for operating a boiler includes sensing a demand for heat and generating and ignition request to a flame safety controller. An ordered succession of evaluation modes compares normal operation to actual operation of control devices through the step of controlled ignition and transitions to a failure mode if an evaluation mode is not successfully completed. In addition, a series of status modes with each status mode being represented as an input condition are tested. A relative priority structure is established among the status modes and a unique message is associated with each status mode having an input condition that is true. Testing of the individual status modes proceeds in a predefined order until a status mode in a true condition is found and the unique message is displayed. In multiple boiler installations, a sequencer maintains a record of run times, determines an energy need and issues control commands to vary a firing rate or add or delete boilers giving consideration to the runtimes of the boilers.

U.S. Pat. No. 7,574,120, issued Aug. 11, 2009 to Patterson, et al, puts forth systems and methods for estimating and indicating temperature characteristics of temperature controlled liquids. A system in accordance with one exemplary embodiment of the present disclosure has a tank filled at least partially with a liquid, such as water, and the system has a plurality of temperature sensors mounted on the tank. During operation, a controller compares temperatures sensed by these temperature sensors to a predefined temperature profile for the liquid within the tank in order to estimate the likely temperature characteristics of such liquid. The controller then reports these estimated temperature characteristics via a user interface. As an example, the controller may estimate and report the amount of liquid above a threshold temperature that can be drawn from the tank. Based on the reported temperature characteristics, a user may make decisions about whether or how to use liquid drawn from the tank.

U.S. Pat. No. 7,613,855, issued Nov. 3, 2009 to Phillips et al, indicates a modular control system and method for water heaters which tracks usage. The water heater comprises a tank, a heating element, a first controller, and a second controller. The heating element is coupled to the tank. The first controller is mounted on the tank and has a first communication port. The second controller has a second communication port communicatively coupled to the first communication port of the first controller. The first controller is configured to control the heating element in accordance with a first algorithm in an absence of the second controller, and the second controller is configured to control the heating element in accordance with a second algorithm.

Three U.S. patents, U.S. Pat. No. 7,065,431 issued Jun. 20, 2006; U.S. Pat. No. 7,603,204 issued Oct. 13, 2009 and U.S. Pat. No. 7,672,751 issued Mar. 2, 2010 to Patterson et al, are for a system for controlling a temperature of a liquid residing within a tank comprising a temperature sensor, a temperature control element, memory, and logic. The temperature sensor is configured to detect the temperature of the liquid residing within the tank, and the temperature control element is coupled to the tank. The memory stores data indicative of a usage history of the tank, and the logic is configured to automatically control the temperature control element based on the data.

Two U.S. patents, U.S. Pat. No. 7,712,677 issued May 11, 2010 and U.S. Pat. No. 6,955,301 issued Oct. 18, 2005 to Munsterhuis et al, provide an improved heater and method of controlling the same. The water heater has the combination of a tank for holding water, a heater for heating the water, a controller having logic to regulate the heater, and first and second sensors. Each of the sensors detects the water temperature at different areas within the water heater. The sensors also provide the controller with signals corresponding to the detected water temperature. In response to these signals, the controller regulates the heater when at least one of the signals of the first and second sensors satisfies at least one predetermined state condition.

U.S. Pat. No. 5,968,393, issued Oct. 19, 1999 to Demaline, shows a system for controlling the heating of water in the tank, water in tank adapted to be heated by a first heater and a second heater, the system comprises a timer adapted to keep time, and a sensor to monitor the temperature of the water in the tank at a first position and the temperature of the water in the tank at a second position. The system is adapted to set a first set point temperature at a specified time and the first set point temperature is varied by the system over time. The system is also being adapted to set a second set point temperature the second set point temperature also being varied by the system over time. The system has an activator to activate the first heater to maintain the temperature of water in the tank at the first position at about the first set point temperature at a specified time. The system has an activator to activate the second heater to maintain the temperature of water in the tank at the second position at about the second set temperature at a specified time.

What is needed is an electronic control system for boilers which interfaces with a set of control relays, integrated relays that allow control of boiler operating temperature and set points, and microcontroller operated remote sensors that provide data and logging feedback and provide built-in failsafe control and continual remote monitoring capability of a number of parameters to enable discovery of faulty components in the devices as well as in the boilers, as well as allowing the user to reduce energy costs by reducing the output temperature of a boiler system during times of reduced demand or for adjustments of seasonal functionality.

### BRIEF SUMMARY OF THE INVENTION

An object of the present invention is to provide an electronic control system for boilers which uses remote sensors, data logging, and communications and which comprises a processor unit for processing and displaying information, communication, and for interfacing with a set of control relays, integrated relays that allow control of boiler operating temperature and set points, and microcontroller operated remote sensors that provide data and logging feedback and provide built-in failsafe control and continual remote monitoring capability of a number of parameters to enable discovery of faulty components in the devices as well as in the boilers, as well as allowing the user to reduce energy costs by reducing the output temperature of a boiler system during times of reduced demand or for adjustments of seasonal functionality.

Using a PC or integrated access, users will have access to time and temperature data from user defined sensors. Using this data, users can make informed decisions about system operation. This can include boiler temperatures tailored to seasonal climate changes or specific operating installations. This control can be an integral part in minimizing energy and operating costs.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a diagrammatic view of the components of the electronic control system for boilers of the present invention;

FIG. 2 is a perspective view of the replacement aquastat of the electronic control system for boilers of the present invention;

FIG. 2A is a perspective enlarged view of the wiring terminal of the replacement aquastat showing the flow meter, tamper switch, and boiler connections of the electronic control system for boilers of the present invention;

FIG. 3 is a flat view of a personal computer screen for the boiler setup showing the status of the system;

FIG. 4 is a flat view of a personal computer screen for the boiler setup showing the sensors of the system;

FIG. 5 is a flat view of a personal computer screen for the boiler setup for editing or adding sensors;

FIG. 6 is a flat view of a personal computer screen for the boiler setup showing the scheduling of the system including daily set points for each boiler;

FIG. 7 is a flat view of a portion of a personal computer screen for the boiler setup showing the reporting tab, wherein the control can be configured to call a remote computer and supply boiler sensor history data through the phone line;

FIG. 8 is a flat view of a portion of a personal computer screen for the boiler setup showing the file settings for loading and saving configurations and schedules;

FIG. 9 is a flat view of a portion of a personal computer screen for the boiler setup for setting the boiler clock to the current computer clock;

FIG. 10 is a flat view of a portion of the main control board screen displaying the status screen showing the current day and time and the boiler temperature information for up to three boilers and the loop water temperature;

FIG. 11 is a flat view of a portion of a personal computer screen displaying the main menu functions including all of the options for the operation of the system;

FIG. 12A is a flat view of a portion of a personal computer screen displaying the set point setting screen for a single boiler on a single day showing four set points;

FIG. 12B is a flat view of a portion of a personal computer screen displaying the set point setting screen for a single boiler on a single day showing two set points.

### DETAILED DESCRIPTION OF THE INVENTION

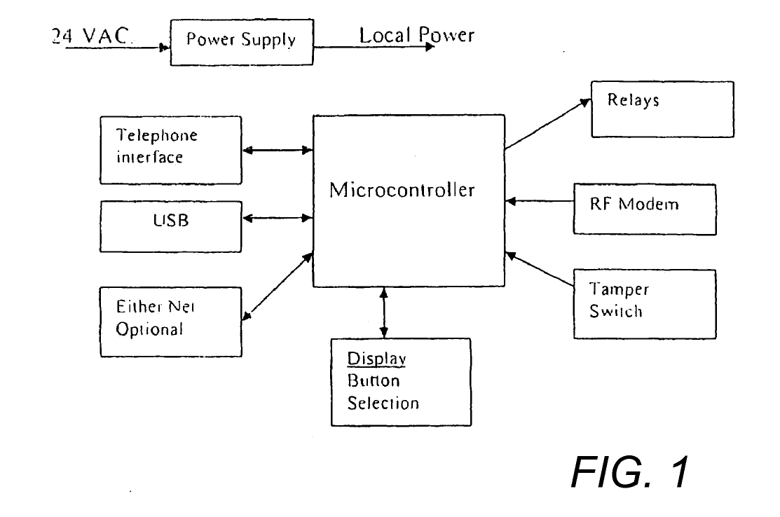

In FIGS. 1-12B, an electronic control system for boilers comprises at least one remote sensor, usually one sensor for each boiler. Each sensor comprises at least one thermistor based sensor connected to a sensor printed circuit board via a three wire Molex style jack and a high temperature wire to allow remotely mounting the sensor transmitter away from heat sources. Each remote sensor communicates through a radio frequency link to the main control board. Each remote sensor further comprises an embedded microcontroller within the remote sensor to facilitate communication with the main control board and to provide battery voltage and temperature data feedback at preprogrammed limed intervals. An onboard battery provides power to the remote sensor, and a battery ground provided through the Molex connector to allow the remote sensor to be stored without operating.

The electronic control system for boilers further comprises a main control board communicating with the remote sensor for the purpose of returning temperature data from the at least one remote sensor to the main control board to provide an electronic control system for boilers. The main control board comprises a microprocessor and a radio frequency receiver to provide data output and radio frequency signal strength output to the microprocessor, the microprocessor logging input information into an external EEPROM memory, a real time clock with battery backup to provide time stamping for all logged input information, a light emitting diode display contained on the main control to visually display system data including temperature and timing set points, buttons on the main control board for parameter modification, an integrated telephone modem interface communicating with the main control board to provide remote accessibility to the electronic control system; the microprocessor unit interfacing with a set of integrated control relays to at least one boiler, the integrated control relays allowing control of boiler operating temperature and set points, to provide an electronic control system for boilers to allow a user to reduce the output temperature of a boiler system during times of reduced demand and to make adjustments for seasonal functionality; bypass switches on the integrated control relays to activate a boiler aqua stat in the event of a failure in the programmed system. Program features comprise continual programmed monitoring of the returning temperature data from the at least one remote sensor to the main control board displayed over real time in conjunction with the programmed timing set points reveal and alert a user to any flaws in the programmed controls as well as flaws in the at least one boiler for reprogramming in real time as needed for network and USB local access and servicing, for failsafe operation of the programmed controls, and for rapid response in real time to fix failed boiler equipment.

The system further comprises means for connectivity to a network, such as a universal serial bus cable connection or a module incorporating Ethernet connectivity.

The integrated control relays preferably comprise three relays to allow interruption of a normal high temperature aqua stat to produce lower boiler temperatures on up to three separate boilers.

The system further comprises a tamper switch input to limit unauthorized access.

An electronic control method for boilers comprises the following steps:

A first step comprises installing at least one remote sensor on at least one boiler, wherein the sensor comprises at least one thermistor based sensor connected to a sensor printed circuit board via a three wire Molex style jack and a high temperature wire to allow remotely mounting the sensor transmitter away from heat sources. The remote sensor communicates through a radio frequency link to the main control board. An embedded microcontroller within the remote sensor facilitates communication with the main control board and provides battery voltage and temperature data feedback at preprogrammed limed intervals. An onboard battery provides power to the remote sensor, and a battery ground provided through the Molex connector allows the at least one remote sensor to be stored without operating.

A second step comprises providing a main control board communicating with the remote sensor for the purpose of obtaining temperature data from the remote sensor to the main control board to provide an electronic control system for boilers. The main control board comprises a microprocessor and a radio frequency receiver to provide data input and radio frequency signal strength input to the microprocessor. The microprocessor logs input information into an external EEPROM memory. A real time clock with battery backup provides time stamping for all logged input information and time control for operations. A light emitting diode display contained on the main control visually displays system data including temperature and timing set points. Buttons on the main control board enable parameter modification. An integrated telephone modem interface communicates with the main control board to provide remote accessibility to the electronic control system. The microprocessor unit interfaces with a set of integrated control relays to each boiler, the integrated control relays allowing control of boiler operating temperature and set points, to provide an electronic control method for boilers to allow a user to reduce the output temperature of a boiler system during times of reduced demand and to make adjustments for seasonal functionality. The method further comprises providing bypass switches on the integrated control relays to activate a boiler aqua stat in the event of a failure in the system for failsafe operation of the programmed controls and to allow adjustment for high demand. Continual programmed monitoring of the returning temperature data from the at least one remote sensor to the main control board displayed over real time in conjunction with the programmed timing set points reveal and alert a user to any flaws in the programmed controls as well as flaws in the at least one boiler for reprogramming in real time as needed for rapid response in real time to fix failed boiler equipment.

Means for connectivity to a network are provided by a universal serial bus cable connection or a module incorporating Ethernet connectivity.

The step of providing integrated control relays comprises providing three relays to allow interruption of a normal high temperature aqua stat to produce lower boiler temperatures on up to three separate boilers.

The method further comprises a step of activating a tamper switch input to limit unauthorized access.

A 4-20 MA flow sensor may be connected to measure system flow if desired. Power is supplied to this board from a standard 24 volt AC source typical to boiler applications.

In use, using a personal computer or integrated access, users will have access to time and temperature data from user defined sensors. Using this data, users can make informed decisions about system operation. This can include boiler temperatures tailored to seasonal climate changes or specific operating installations. This control can be an integral part in minimizing energy and operating costs.

The senders should be mounted to the bottom or the side of the piping. They must be strapped to the pipe to get proper temperature readings. The wire must be brought away from the hot pipe as soon as possible. The senders must be insulated; the wireless transmitter can be strapped to the outside of the insulation.

A new boiler aqua stat is supplied with the sender and receiver attached. The new well must be installed. Both senders will go into the new well which is supplied with the unit.

The loop probe is installed after the mixing valve using the same method as above. The return probe is mounted to the return line using the same method as the other probes.

When setting the control the boost temperature is 15 Deg. The minimum loop temperature is 115 deg. Hysteresis temperature setting is 10 deg.

### Starting Settings

Monday to Saturday; 4 AM 170 deg, 11 AM 130 deg, 4 PM 160 deg, 11 PM 130 deg Sunday; 4 AM 160 deg, 11 AM 140 deg, 4 PM 160 deg, 11 PM 130 deg

In FIG. 1, the software operation comprises using a personal computer or integrated access, users will have access to time and temperature data from user defined sensors. Using this data, users can make informed decisions about system operation. This can include boiler temperatures tailored to seasonal climate changes or specific operating installations. This control can be an integral part in minimizing energy and operating costs.

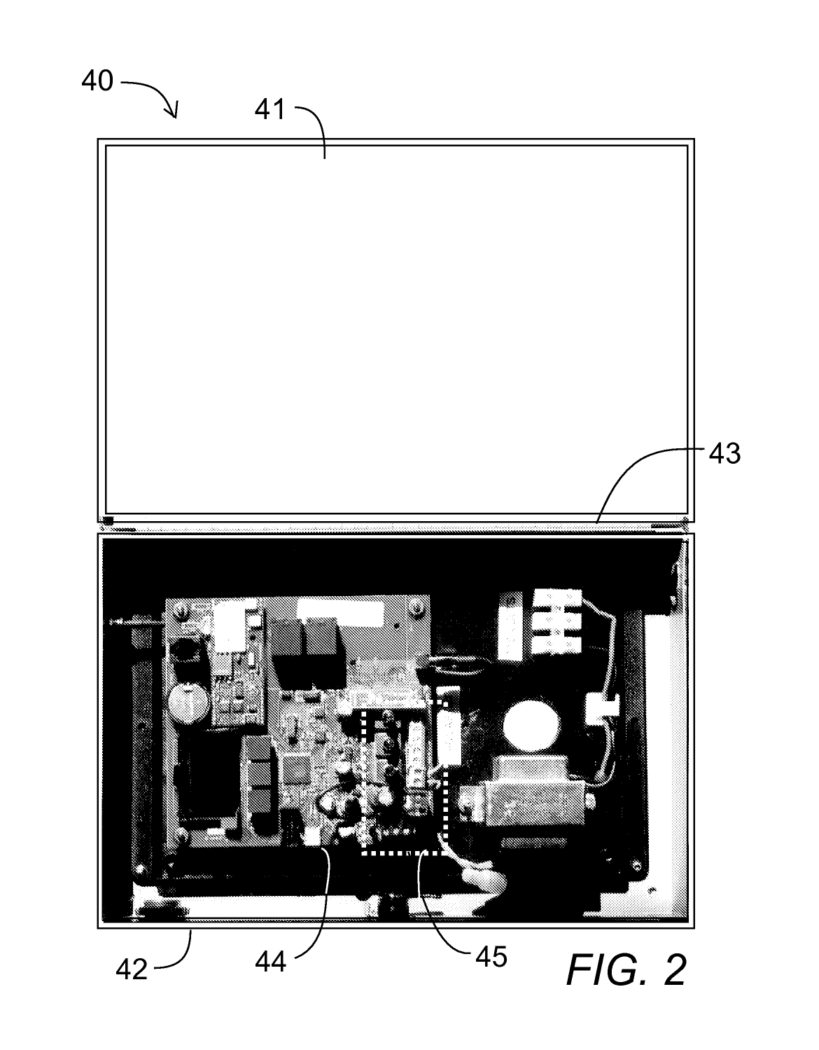

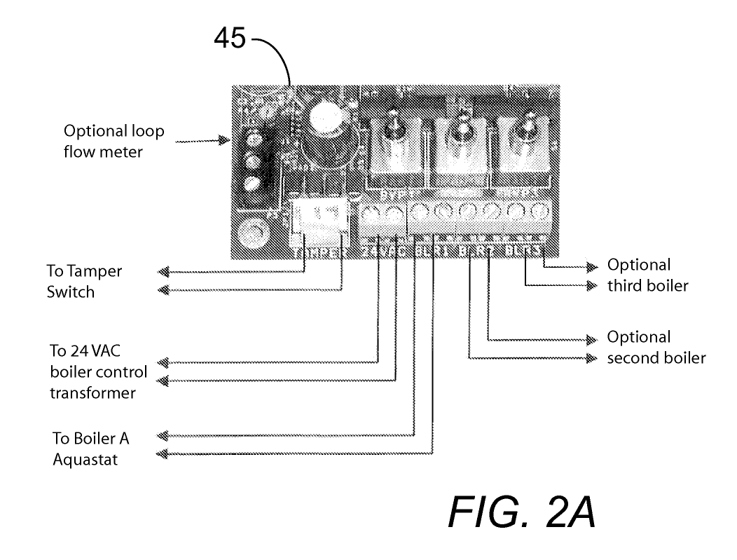

In FIG. 2, the replacement aquastat 40 is housed in a metal case forming an insulated enclosure having a base 42 and a cover 41 connected by a hinge 43 and the aquastat circuit board in the case includes a USB port 44 and a wiring terminal 45 (marked by a surrounding dashed line), which is shown enlarged in FIG. 2A. In setting up, the process of making connections comprises:
1. Connecting the replacement Aquastat 40 by cutting the connection on one lead of the Aquastat. Connect the cut wire ends to the two BLR1 terminals using an additional wire.
2. Connecting any additional boilers as done with the first boiler.
3. Connecting the outer two terminals of the tamper switch connector to the tamper switch.
4. OPTIONAL: Connecting the flow meter ground to the terminal closest the mounting hole. Connecting the signal wire to the center terminal and connect the V+ connection to the remaining terminal.
WARNING: Never connect any other device or connection to the flow meter terminals.
5. Connecting a 24 VAC source capable of supplying 300 ma to the 24 VAC terminals
6. Connecting a PC to the USB connector on the board (Not shown).

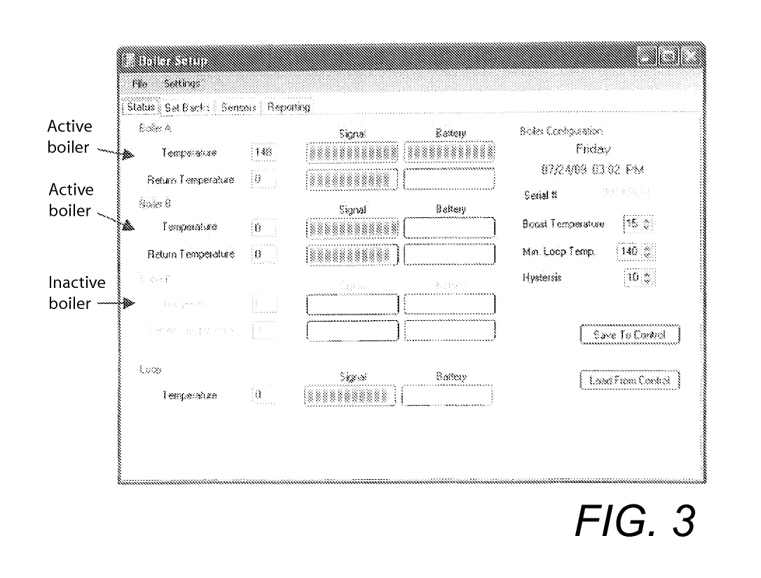

In FIG. 3, Basic Program information: Click the desk top icon to start the program. When the program first runs, it will attempt to connect to the boiler. If the computer is not connected to a boiler, the program will allow opening, editing and saving of configuration information to the computers storage media. Be sure to save the configuration to a storage media before connecting to a boiler. (See Saving Configurations for details.) Configuring the boiler Status Tab When the computer is connected to a boiler control, the active boilers will appear as shown in FIG. 3. Signal and battery status will show for each installed sensor. The boiler controls basic configuration data is shown in the boiler configuration box. The day, date, and time indicated are the system time at the control. A unique serial number is embedded in each control.

### Boiler Configuration Box:

Hysteresis: This is the temperature variance below the programmed set point the control will allow before turning on the boiler. For example if the set point is 140° F. and the temperature falls below 130° F. the boiler will turn on. The same hysteresis is used for all boilers.
Minimum Loop Temperature: The lowest temperature allowed before activating the boost temperature offset. When the loop temperature falls below this set point, the boiler will turn on and raise the boiler temperature. Boiler temperature will increase to the boiler set point plus the boost temperature offset.
Boost Temperature: The number of degrees to raise the boiler temperature above the boiler set point before shutting off the boiler. This is used only if the loop temperature falls below the programmed minimum. For example if the minimum loop temperature is set for 120° F. and it falls to 119° F., the boiler will start up. If the boiler set point is 140° F. and the boost temperature offset is set for 150° F., the boiler water temperature will raise to 155° F. before turning off the boiler.

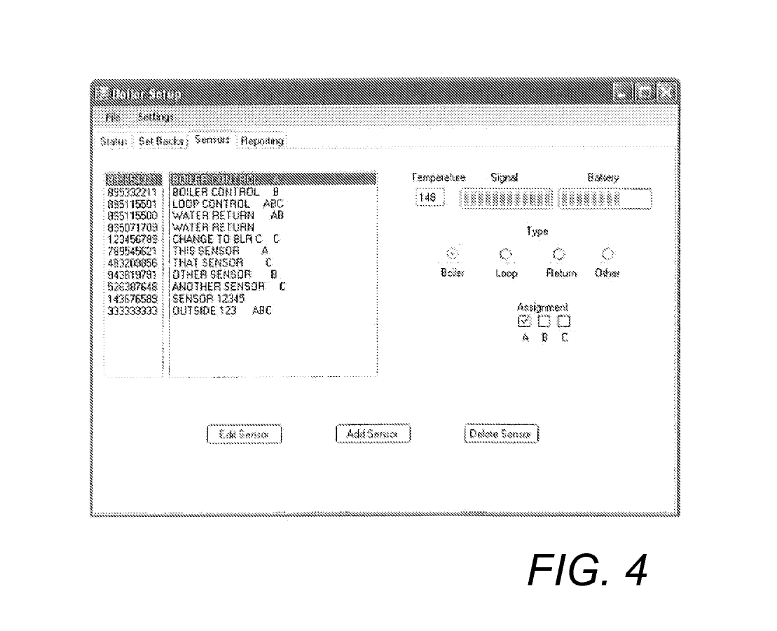

In FIG. 4, press the Sensors tab to bring up the sensors screen. Select a sensor to view its current signal, temperature and battery condition. Letters following the description indicate the assignment to a boiler.

There are four types of sensors that may be defined in the control. Boiler control sensors monitor the boiler temperature. This is the temperature controlled with setbacks, boost and hysteresis settings. Each boiler can be assigned to one individual sensor. The loop sensor monitors loop water after the mixing valve. The control activates the boost function based on the minimum loop temperature read by this sensor. One loop sensor must be installed in a system. Only one loop sensor can be installed. Return and other sensors are pre defined sensors that provide diagnostic and comparative references. They have no active function within the control.

Sensor serial numbers are programmed into each sensor. Controls will not log or recognize sensors that have not either been entered into the control or saved to the control through the PC program.

In FIG. 5, for editing or adding sensors, press the [Edit Sensors] or [Add Sensors] button and the sensors screen will pop up. Enter the serial number, description, assignment, and type of sensor. Press [OK] and the data will be added to the sensors list.

To activate the sensor, press [Save To Control] on the status tab.

To delete a sensor, sensors may be removed from the system by selecting the sensor to be deleted and pressing [Delete Sensor]. You will be asked for confirmation before the sensor is removed.

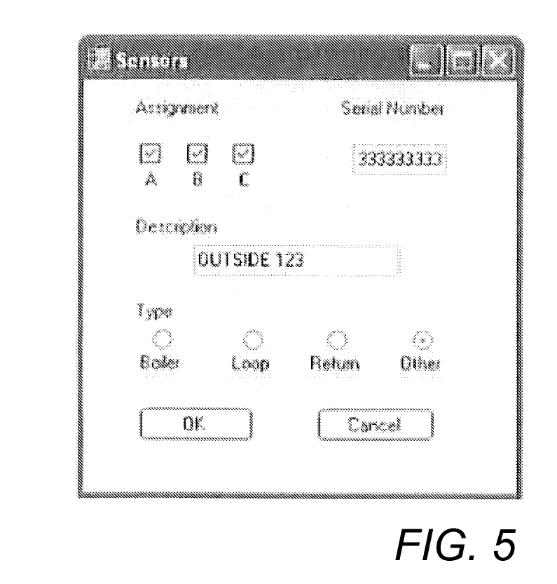

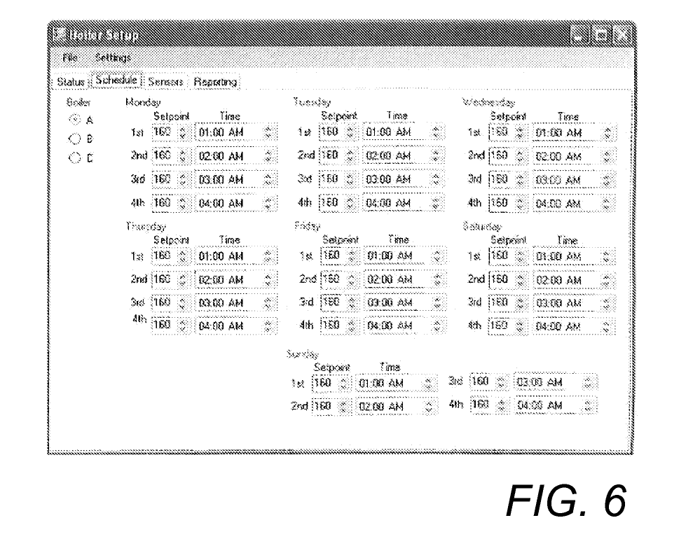

In FIG. 6, for scheduling, press the schedule tab to bring up the schedule screen. The schedule allows the user to create up to four set points or temperature changes per day. Set the times and temperatures for the day you want to change. You may click on the value to be changed and enter it on the keyboard or use the up and down buttons to change the value. Times must be entered from earliest in the 1^{st} row and the latest in the 4^{th} row. If times are entered wrong, an error message will indicate the location of the error. Correct any errors before saving to the boiler. Continue to make changes for each day of the week. Click the ‘B’ button to change to the second boiler and set the times and temperatures desired. Repeat the process for the ‘C’ boiler. The schedule may be saved independently for use on other boilers. See Saving configurations for details.

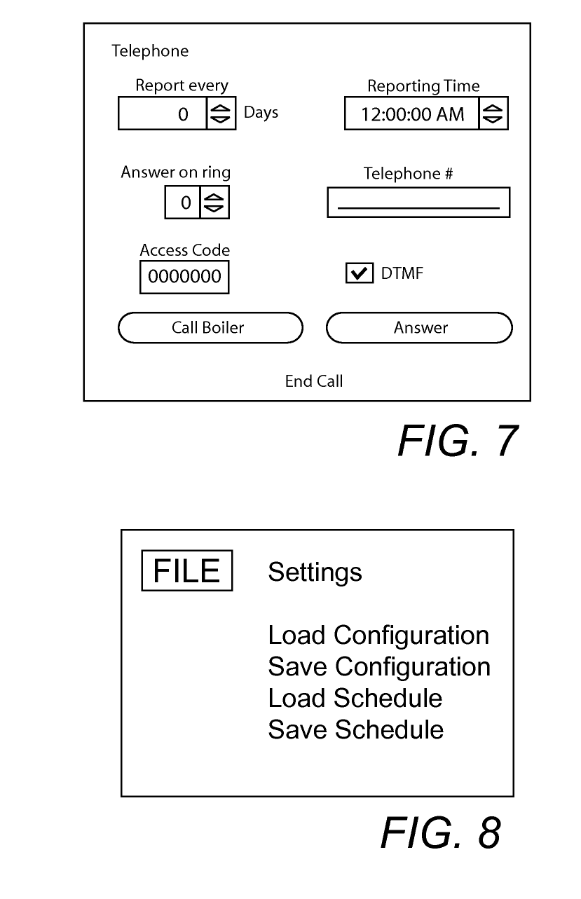

In FIG. 7, to use the reporting tab, the control can be configured to call a remote computer and supply boiler sensor history data through the phone line. When the control initiates a call it will download any available sensor data to the remote computer. The remote computer must be on and set to answer the phone. See answer below for details.

A remote computer can also call a control and make changes to its operation. To initiate a call, put the controls phone number in the telephone number box and its access code in the access code box then press “Call boiler”. The connection may take a few minutes. Call progress will be indicated below the End Call button. Once connected, all the settings available locally are available through the program. If the changes are to be applied to the control they must be saved by clicking “Save to control”. Be sure all changes are correct before saving to the control.

Using the telephone configuration box of FIG. 7, set it to report as frequently as desired under Report every xx Days: This box contains a number indicating the number of days to hold data before automatically reporting. The default setting is 0 which disables automatic reporting. 0 to 31 days are allowed.

Under Reporting Time, input the time of day that automatic reporting occurs.

Under Answer on Ring, input the number of rings allowed before answering the dial up modem. Setting the number to zero will cause the system not to answer. 0 to 8 rings are allowed.

Under setting the DTMF to the phone, if this box is checked, dialing will be DTMF (touch tone dialing). If this box is unchecked, dialing will be Pulse.

Under Telephone Number, input the number to be dialed when automatic reporting is enabled. The following characters are allowed in addition to 0-9; “W, “,”, “_”, “&”. The symbols have the following significance:
W Wait for dial tone
, Pause for 2 seconds
& Wait for silence for 5 seconds
_ No operation

Using the Access Code, set a 6 digit access code for remote access operation. 0-9 and A-F are allowed. Be sure to verify the access code before saving any changes to the control.

Using Call Boiler, pressing this button initiates a call to a boiler using the telephone number set in the Telephone # box. Once connected, all the features of a local USB connection are available.

Using Answer, pressing this button tells the modem to wait for a call from the boiler. When a call is received, the file will be stored on the hard drive of the computer and can be viewed by pressing “View log” in the file menu and selecting the file.

Using End Call, this button will only be available when a connection has been made. Press it to end a call.

In FIG. 8 for using the File Menu, the following procedures apply:

Using Saving Configurations, when a boiler is first connected, the program will get all the scheduling, sensor, and reporting data from the control. The user may make any changes to this information and save it as a configuration file. The user selects “File” on the menu bar and “Save Configuration” to save all the settings made. The user enters a file name for the installation and presses [Save]. Set backs, sensor information, boiler configuration set points and reporting information are saved with the configuration file. This data may later be recalled in case a control needs to be replaced.

Using Loading configurations, configurations may be loaded from the file menu as well by selecting “File” on the menu bar and “Load Configuration”. The configuration data will be loaded into the computers program memory. “Save to Control” is pressed to save the data to a connected control. Any time a control disconnect and reconnect occurs, the configuration data is replaced in the computer program with the connected boilers configuration.

Using Saving and Loading Schedules, schedules may independently be saved or loaded from a file. Only the schedule data will be modified or saved when using load or save schedule. To activate the schedule it must be saved to the control. (See Saving to the Control for details.)

Using Saving to the Control, any time changes are made on the computer program that are desired to be activated in the boiler, they must be saved to the control. The configuration information is saved to the control by pressing the [Save to Control] button. All settings will become active immediately after saving.

Using Loading From the Control, control settings will be automatically retrieved from the control each time a user is connected to it. If changes are made to the settings that are not desired and have not been saved to the control, pressing [Load from Control] will reload the last saved settings from the control.

Sensor data is logged in the control memory every ten minutes. This log contains tamper and bypass switch activity, day and time information, and average temperature for the time period. This data may be saved to a CSV file by selecting “Save Log” in the file menu. Downloading Log will appear at the top of the screen and a progress bar will start. The user will then be prompted to enter a file name for the log. After saving, data may be viewed or graphed in a spreadsheet program. Logs are stored from newest data to oldest.

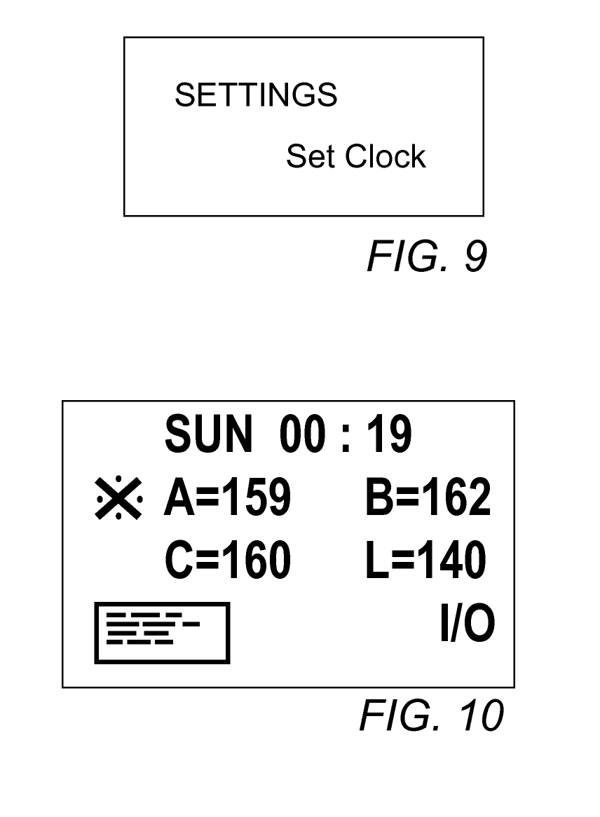

In FIG. 9, using Set Clock, the boiler clock may be set to the current computer clock by clicking on the settings menu and “Set Clock”. Be sure the system time is accurate before setting the boiler clock.

In FIG. 10, the status screen is the first screen shown on power up and after exiting the screen saver. At the top of the screen, it shows the current day and time in 24 hour format. Below that is the boiler temperature information for up to 3 boilers labeled A, B, and C. L is the loop water temperature.

Operation of this control may be bypassed for any boiler by moving the toggle switch for that boiler to the UP position.
BYP This will show up in place of the temperature on a bypassed boiler.
[symbol] This icon appears any time a boiler is heating under system control.

Icons will appear at the bottom of the screen to indicate the function of the buttons located directly under the display. Functions are described below.
[symbol] This is the MENU icon. Press the button under the menu icon to view the main menu.
[symbol] After pressing the menu button, the UP and DOWN icons will appear. The buttons under the icons are used to navigate through each menu selection. These icons will also appear within a menu selection. Data that can be changed will appear flashing and may be adjusted up or down.
[symbol] This is the TAB icon. The button below this icon is used to advance through the changeable settings on the display. This moves the flashing selection indication to the next selection. After the last selection is changed, the tab button is pressed again to exit the screen and return to the menu.

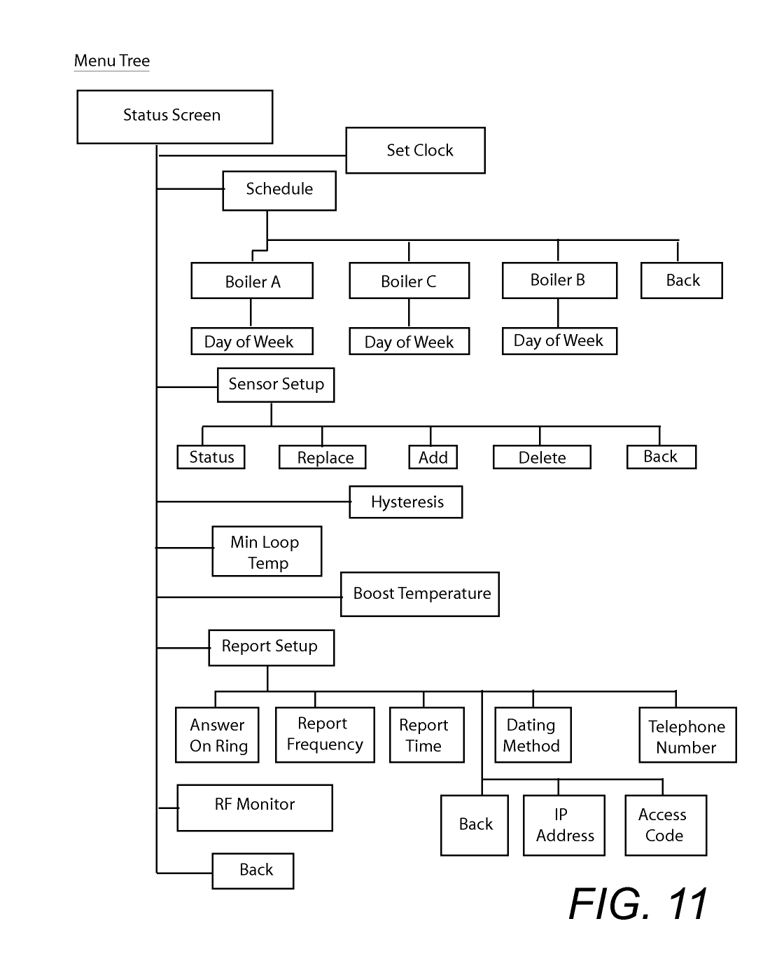

In FIG. 11, the Main Menu Functions are used as indicated below.

After pressing Menu from the status screen, the following options are available.
Press the button under the Menu icon again to enter the function.
Return in any menu returns to the previous menu.
Set Clock allows on site setting of the clock. Time must be entered in a 24 hour format.
Schedule system configuration is most easily preformed through a PC, however settings may be changed locally if desired. The schedule function allows the user to change the time and set point information by boiler and by day. First the boiler to change is selected. Next the week day for which to change the setting for is selected. Tabbing through the settings allows changing the times and temperatures as desired.

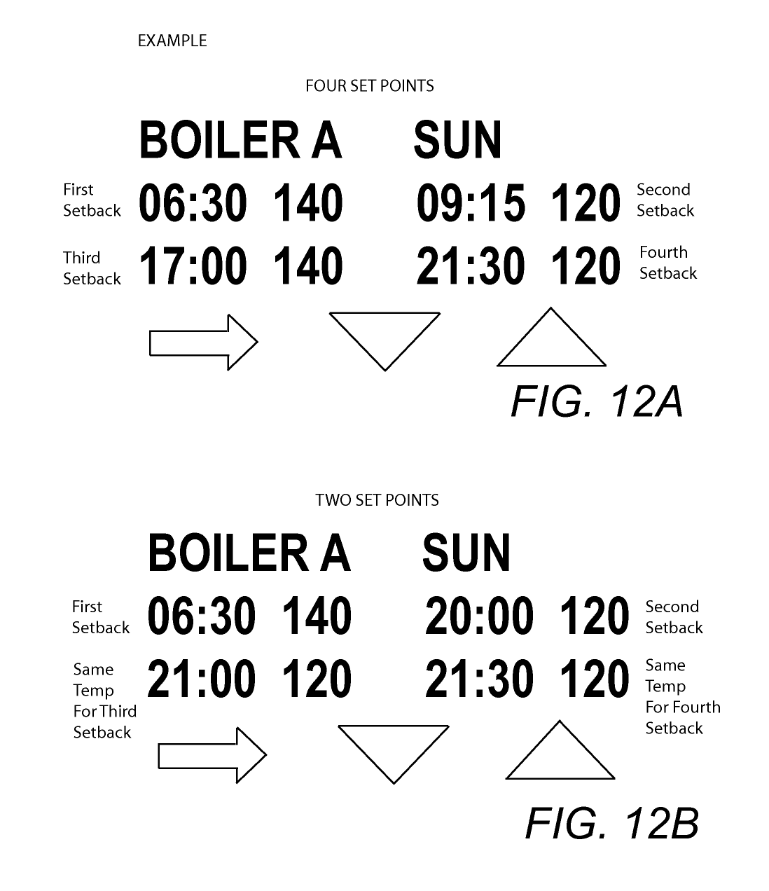

In FIGS. 12A and 12B, an example screen shows two or four set points. Set points must be set chronologically as shown, from earliest to latest for proper operation. If only two set points or changes are desired per day, change the second set of times to later than the last change and change both temperatures to the same as the latest change for that day.

### Sensor Setup

Sensor management is done by sensor serial number. During initial system installation, sensors are assigned to specific functions. Each system must have at least a loop water sensor and a boiler control sensor to operate. Selecting “Sensor Setup” opens a sub menu allowing the user to view and change the status of sensors in the system.
Status: The status of any sensor may be viewed by selecting the serial number of that sensor then pressing tab. This will tell you the last reported signal strength and battery voltage of that sensor.
Replace: Sensors can be replaced by selecting the serial number of the sensor to be replaced and changing it to the number of the new sensor.
Add: Sensors may be added by first entering the serial number. Next select the type or function of the sensor. Loop and Boiler are control sensors and will have an impact on the system operation. Only one sensor per boiler may be designated for each function for loop and boiler temperature. Additional sensors may be added for monitoring other functions. Finally if you are installing a loop or boiler sensor, select the boiler it will operate with.
Delete: Sensors may be removed from the system by selecting the serial number to remove then press the tab button.

### Hysteresis

Hysteresis allows the user to change the number of degrees farenheit the boiler temperature must drop from the set point for the boiler to start heating.

### Minimum Loop Temperature

If the loop temperature drops below the minimum loop temperature, the boiler will heat the water up to the boiler set point plus the boost temperature value. For example, if the following conditions exist:
Boiler set point: 130° F. Boiler temperature: 130° F.
Minimum loop temperature: 120° F. Loop temperature: 119° F.
Boost temperature: 10° F.
   The control will temporarily turn up the boiler to 140° F. to compensate for the low loop temperature. This setting may be adjusted from 90° F. to 180° F.

### Boost Temperature

See Minimum Loop Temperature for explanation. This setting may be adjusted from 0-30° F.

### Report Setup

Data is constantly accumulated in system memory. As memory becomes full, older data is overwritten with new data. If saving this data is desired, it can be automatically reported through a dial up or IP connection. (See Reporting Tab for details on how to set up reporting through the computer.) Selecting “Report Setup” opens up a sub menu containing selections that define how the control is to report.
Answer on Ring: Number of rings allowed before answering dial up modem. Setting the number to zero will cause the system not to answer. 0 to 8 rings are allowed.
Report Frequency: The default setting is 0, which disables automatic reporting. Numbers are the number of days to hold data before reporting. 0 to 31 days are allowed.
Report time: The time of day that automatic reporting occurs.
Dialing method: DTMF, Pulse or IP is available depending on the system in use.
Telephone number: The number to be dialed when automatic reporting is enabled.
Access Code: Sets a 6 digit access code for telephone operation. Allowable values are 0-9 and A-F for each digit resulting in over 16 million possibilities.
IP Address: NOT CURRENTLY AVAILABLE

### RF Monitor

The RF monitor function allows the user to see the no signal noise level and the last received signal level. Values for the noise level should appear between 1.2 and 1.9 for most installations. Values for the last received signal should range from 1.9-2.9. Higher numbers for signal level and lower numbers for noise levels are better. If a sensor's signal level is less than 0.2 above the noise level, it may be necessary to re-adjust the placement of the transmitter for that sensor.

### Installing the Sensors

After configuring the sensors on the control, wireless sensors must be installed on the boiler. Sensors contain a battery that is enabled when the sensor cable is plugged into the connector. Sensor cables are made of high temperature wire and may be exposed to temperatures of up to 250° F. Sensor transmitters are housed in plastic enclosures and contain batteries. They should be mounted in locations that would not exceed 120° F. Antennas should be oriented vertically and be as free from nearby conductors as possible.

To verify the sensors, allow the system to receive data for at least 10 minutes then verify the sensors are all responding by checking the signal levels, temperature and battery voltages on the display or PC.

To determine sensor failure, if a sensor probe fails in operation, the transmitter will send a zero reading to the control. If the transmitter fails, or a sensor fails, the following conditions will occur:

If the sensor is a boiler sensor, the control will enable the boiler aquastat and will stop controlling boiler temperature.

If the sensor is a loop sensor, the control will enable the boost temperature offset. This will cause the boiler to operate above the set point by the amount set by the boost temperature offset.

It is understood that the preceding description is given merely by way of illustration and not in limitation of the invention and that various modifications may be made thereto without departing from the spirit of the invention as claimed.

What is claimed is:

1. An electronic control system for boilers comprising:
at least one remote sensor, the at least one sensor comprising at least one thermistor based sensor connected to a sensor personal computer board via a three wire Molex style jack and a high temperature wire to allow remotely mounting the sensor transmitter away from heat sources, the at least one remote sensor communicating through a radio frequency link to the main control board; the at least one remote sensor further comprising an embedded microcontroller within the at least one remote sensor to facilitate communication with the main control board and to provide battery voltage and temperature data feedback at preprogrammed limed intervals, an onboard battery to provide power to the at lest one remote sensor, and a battery ground provided through the Molex connector to allow the at least one remote sensor to be stored without operating;
a main control board communicating with the at least one remote sensor for the purpose of returning temperature data from the at least one remote sensor to the main control board to provide an electronic control system for boilers, the main control board comprising a microprocessor and a radio frequency receiver to provide data output and radio frequency signal strength output to the microprocessor, the microprocessor logging input information into an external EEPROM memory, a real time clock with battery backup to provide time stamping for all logged input information, a light emitting diode display contained on the main control to visually display system data including temperature and timing set points, buttons on the main control board for parameter modification, an integrated telephone modem interface communicating with the main control board to provide remote accessibility to the electronic control system; the microprocessor unit interfacing with a set of integrated control relays to at least one boiler, the integrated control relays allowing control of boiler operating temperature and set points, to provide an electronic control system for boilers to allow a user to reduce the output temperature of a boiler system during times of reduced demand and to make adjustments for seasonal functionality; bypass switches on the integrated control relays to activate a boiler aqua stat in the event of a failure in the programmed system; continual programmed monitoring of the returning temperature data from the at least one remote sensor to the main control board displayed over real time in conjunction with the programmed timing set points reveal and alert a user to any flaws in the programmed controls as well as flaws in the at least one boiler for reprogramming in real time as needed, for failsafe operation of the programmed controls, and rapid response in real time to fix failed boiler equipment.

2. The system of claim 1 further comprising means for connectivity to a network.

3. The system of claim 2 wherein the means for connectivity to a network comprises a universal serial bus cable connection.

4. The system of claim 2 wherein the means for connectivity to a network comprises a module incorporating Ethernet connectivity.

5. The system of claim 1 wherein the integrated control relays comprise three relays to allow interruption of a normal high temperature aqua stat to produce lower boiler temperatures on up to three separate boilers.

6. The system of claim 1 further comprising a tamper switch input to limit unauthorized access.

7. An electronic control method for boilers comprising:
a first step of installing at least one remote sensor on at least one boiler, the at least one sensor comprising at least one thermistor based sensor connected to a sensor personal computer board via a three wire Molex style jack and a high temperature wire to allow remotely mounting the sensor transmitter away from heat sources, the at least one remote sensor communicating through a radio frequency link to the main control board; the at least one remote sensor further comprising an embedded microcontroller within the at least one remote sensor to facilitate communication with the main control board and to provide battery voltage and temperature data feedback at preprogrammed limed intervals, an onboard battery to provide power to the at lest one remote sensor, and a battery ground provided through the Molex connector to allow the at least one remote sensor to be stored without operating;
a second step of providing a main control board communicating with the at least one remote sensor for the purpose of returning temperature data from the at least one remote sensor to the main control board to provide an electronic control system for boilers, the main control board comprising a microprocessor and a radio frequency receiver to provide data output and radio frequency signal strength output to the microprocessor, the microprocessor logging input information into an external EEPROM memory, a real time clock with battery backup to provide time stamping for all logged input information, a light emitting diode display contained on the main control to visually display system data including temperature and timing set points, buttons on the main control board for parameter modification, an integrated telephone modem interface communicating with the main control board to provide remote accessibility to the electronic control system; the microprocessor unit interfacing with a set of integrated control relays to at least one boiler, the integrated control relays allowing control of boiler operating temperature and set points, to provide an electronic control method for boilers to allow a user to reduce the output temperature of a boiler system during times of reduced demand and to make adjustments for seasonal functionality; providing bypass switches on the integrated control relays to activate a boiler aqua stat in the event of a failure in the system; continual programmed monitoring of the returning temperature data from the at least one remote sensor to the main control board displayed over real time in conjunction with the programmed timing set points reveal and alert a user to any flaws in the programmed controls as well as flaws in the at least one boiler for reprogramming in real time as needed, for failsafe operation of the programmed controls, and rapid response in real time to fix failed boiler equipment.

8. The method of claim 7 further comprising a step of providing means for connectivity to a network.

9. The method of claim 8 wherein the step of providing means for connectivity to a network comprises providing a universal serial bus cable connection.

10. The method of claim 8 wherein the step of providing means for connectivity to a network comprises providing a module incorporating Ethernet connectivity.

11. The method of claim 7 wherein the step of providing integrated control relays comprises providing three relays to allow interruption of a normal high temperature aqua stat to produce lower boiler temperatures on up to three separate boilers.

12. The method of claim 7 further comprising a step of activating a tamper switch input to limit unauthorized access.
